(19) United States
(12) Patent Application Publication
(10) Pub. No.: US 2024/0066853 A1
(43) Pub. Date: Feb. 29, 2024

(54) SYSTEM FOR FORMING A ROOFING MEMBRANE, AND ASSOCIATED METHOD

(71) Applicant: GAF Energy LLC, Parsippany, NJ (US)

(72) Inventor: Caleb David Cheung, San Jose, CA (US)

(21) Appl. No.: 18/455,129

(22) Filed: Aug. 24, 2023

Related U.S. Application Data
(60) Provisional application No. 63/400,646, filed on Aug. 24, 2022.

(51) Int. Cl. B32B 37/20; B32B 27/08; B32B 27/32; B32B 37/06; B32B 37/10; B32B 38/00; B32B 38/06; E04D 5/06; E04D 5/10

(52) U.S. Cl. CPC B32B 37/203; B32B 27/08; B32B 27/32; B32B 37/06; B32B 37/10; B32B 38/0004; B32B 38/06; E04D 5/06; E04D 5/10; B32B 2250/02; B32B 2250/03; B32B 2250/242; B32B 2323/00; B32B 2419/06

(57) ABSTRACT

A method includes obtaining a first roll of a first sheet comprising thermoplastic polyolefin and having a width of at least 60 inches; obtaining a second roll of a second sheet comprising thermoplastic polyolefin and having a width of at least 60 inches; heating at least a portion of a width of the first sheet with hot air from a hot air knife to form a heated first sheet; and compressing the heated first sheet and the second sheet between two rollers, to form a laminated roofing membrane, where the heated first sheet and the second sheet directly contact one another without a scrim layer disposed between the heated first sheet and the second sheet.

### CROSS-REFERENCE TO RELATED APPLICATION

This application claims priority to U.S. provisional application Ser. No. 63/400,646, titled “SYSTEM FOR FORMING A ROOFING MEMBRANE, AND ASSOCIATED METHOD,” filed Aug. 24, 2022, the disclosure of which is incorporated by reference herein in its entirety.

### FIELD OF THE INVENTION

The disclosure relates to a roofing membrane, and, more particularly, to a laminated roofing membrane.

### BACKGROUND

Generally, asphalt shingles are used to cover a steep slope roof deck, while roofing membranes, such as a roofing membrane made of thermoplastic polyolefin (TPO), are used to cover a flat roof.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

In some embodiments, a method comprises obtaining a first roll of a first sheet, wherein the first sheet comprises thermoplastic polyolefin (TPO), and wherein the first sheet has a width of at least 60 inches measured parallel to an axis of the first roll of the first sheet; obtaining a second roll of a second sheet, wherein the second sheet comprises thermoplastic polyolefin (TPO), and wherein the second sheet has a width of at least 60 inches measured parallel to an axis of the second roll of the second sheet; heating, in a heating zone, at least a portion of a width of the first sheet with hot air from a hot air knife to form a heated first sheet; and compressing, in a compressing zone, the heated first sheet and the second sheet between two rollers, thereby to form a laminated roofing membrane, wherein the heated first sheet and the second sheet directly contact one another without a scrim layer disposed between the heated first sheet and the second sheet, and wherein the hot air knife is adjacent to the two rollers.

In some embodiments, the hot air knife provides a continuous weld of the first and second sheets.

In some embodiments, the hot air knife heats an entire width of the first sheet.

In some embodiments, the hot air knife heats the entire width of the first sheet with air at a temperature of at least 600° C.

In some embodiments, the hot air knife does not heat an entire width of the first sheet.

In some embodiments, the heating further comprises heating, in the heating zone, at least a portion of a width of the second sheet with hot air from the hot air knife to form a heated second sheet.

In some embodiments, the compressing further comprises compressing, in the compressing zone, the heated first sheet and the heated second sheet between the two rollers, thereby to form the laminated roofing membrane.

In some embodiments, the hot air knife heats an entire width of the second sheet.

In some embodiments, the hot air knife heats the entire width of the second sheet with air at a temperature of at least 600° C.

In some embodiments, the hot air knife does not heat an entire width of the second sheet.

In some embodiments, the widths of the first and second sheets are the same.

In some embodiments, the widths of the first and second sheets are the same, and the widths are 60 inches to 120 inches.

In some embodiments, the widths of the first and second sheets are the same, and the widths are 60 inches.

In some embodiments, a thickness of the first and second sheets are the same.

In some embodiments, the thickness of the first sheet is different than the thickness of the second sheet.

In some embodiments, at least one of the first and second sheets has a thickness of 80 mils.

In some embodiments, each of the first and second sheets has a thickness of 80 mils.

In some embodiments, the method further comprises cutting the laminated roofing membrane, thereby to form a first laminated roofing strip.

In some embodiments, the first laminated roofing strip has a length of 18 inches.

In some embodiments, the first laminated roofing strip has a width of 60 inches.

In some embodiments, the method further comprises cutting the laminated roofing membrane, thereby to form a plurality of laminated roofing strips.

In some embodiments, the method further comprises reheating the laminated roofing membrane; and texturing the reheated laminated roofing membrane.

In some embodiments, the method further comprises texturing the laminated roofing membrane without reheating the laminated roofing membrane.

In some embodiments, the texturing comprises using at least one texturing roller to texture the laminated roofing membrane, thereby to form a textured laminated roofing membrane.

In some embodiments, the texturing comprises using two texturing rollers to texture the laminated roofing membrane, thereby to form the textured laminated roofing membrane.

In some embodiments, the method further comprises cutting the textured laminated roofing membrane, thereby to form a first textured laminated roofing strip.

In some embodiments, the first textured laminated roofing strip has a length of 18 inches.

In some embodiments, the first textured laminated roofing strip has a width of 60 inches.

In some embodiments, the method further comprises cutting the textured laminated roofing membrane, thereby to form a plurality of textured laminated roofing strips.

In some embodiments, neither the first nor second sheet is heated prior to the heating with the hot air knife.

In some embodiments, the laminated roofing membrane excludes any extruded material.

In some embodiments, rotation of the two rollers used to compress the first and second sheets pulls the first sheet and the second sheet through the heating zone and the compressing zone.

In some embodiments, there is no adhesive between the first sheet and the second sheet.

In some embodiments, the method further comprises obtaining a third roll of a third sheet, wherein the third sheet comprises thermoplastic polyolefin (TPO), and wherein the third sheet has a width of at least 60 inches measured parallel to an axis of the third roll of the third sheet; and the compressing further comprises compressing, in the compressing zone, the heated first sheet, the second sheet, and the third sheet between the two rollers, thereby to form the laminated roofing membrane.

In some embodiments, the method further comprises obtaining a third roll of a third sheet, wherein the third sheet comprises thermoplastic polyolefin (TPO), and wherein the third sheet has a width of at least 60 inches measured parallel to an axis of the third roll of the third sheet; and compressing, in a second compressing zone, the laminated roofing membrane and the third sheet between a second set of two rollers, thereby to form a three-layer laminated roofing membrane, wherein the laminated roofing membrane and the third sheet directly contact one another without a scrim layer disposed between the laminated roofing membrane and the third sheet.

### BRIEF DESCRIPTION OF THE DRAWINGS

Reference is made to the drawings that form a part of this disclosure, and which illustrate embodiments in which the materials and methods described herein can be practiced.

FIG. 1 is an isometric view of a system in accordance with some embodiments of the invention.

FIG. 2 is an isometric view of another system in accordance with some embodiments of the invention.

FIG. 3 is an isometric view of another system in accordance with some embodiments of the invention.

FIG. 4 is an isometric view of another system in accordance with some embodiments of the invention.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising” “including,” “having,” and any similar phrase, do not limit the scope of a specific claim to the materials or steps recited by the claim.

In accordance with the discussion herein, in some embodiments, a method includes obtaining a first roll of a first sheet, obtaining a second roll of a second sheet, heating, in a heating zone, at least a portion of a width of the first sheet with hot air from a hot air knife to form a heated first sheet, and compressing, in a compressing zone, the heated first sheet and the second sheet between a first set of two compressing rollers, thereby to form a laminated roofing membrane, wherein the heated first sheet and the second sheet directly contact one another without a scrim layer disposed between the heated first sheet and the second sheet, and wherein the hot air knife is adjacent to the two compressing rollers.

In some embodiments, a portion of the width of the sheet which is heated is 1% to 99% of the width. In some embodiments, the portion of the width of the sheet which is heated is 5% to 99% of the width. In some embodiments, the portion of the width of the sheet which is heated is 10% to 99% of the width. In some embodiments, the portion of the width of the sheet which is heated is 20% to 99% of the width. In some embodiments, the portion of the width of the sheet which is heated is 30% to 99% of the width. In some embodiments, the portion of the width of the sheet which is heated is 40% to 99% of the width. In some embodiments, the portion of the width of the sheet which is heated is 50% to 99% of the width. In some embodiments, the portion of the width of the sheet which is heated is 60% to 99% of the width. In some embodiments, the portion of the width of the sheet which is heated is 70% to 99% of the width. In some embodiments, the portion of the width of the sheet which is heated is 80% to 99% of the width. In some embodiments, the portion of the width of the sheet which is heated is 90% to 99% of the width. In some embodiments, the portion of the width of the sheet which is heated is 95% to 99% of the width.

In some embodiments, the portion of the width of the sheet which is heated is 1% to 95% of the width. In some embodiments, the portion of the width of the sheet which is heated is 5% to 95% of the width. In some embodiments, the portion of the width of the sheet which is heated is 10% to 95% of the width. In some embodiments, the portion of the width of the sheet which is heated is 20% to 95% of the width. In some embodiments, the portion of the width of the sheet which is heated is 30% to 95% of the width. In some embodiments, the portion of the width of the sheet which is heated is 40% to 95% of the width. In some embodiments, the portion of the width of the sheet which is heated is 50% to 95% of the width. In some embodiments, the portion of the width of the sheet which is heated is 60% to 95% of the width. In some embodiments, the portion of the width of the sheet which is heated is 70% to 95% of the width. In some embodiments, the portion of the width of the sheet which is heated is 80% to 95% of the width. In some embodiments, the portion of the width of the sheet which is heated is 90% to 95% of the width.

In some embodiments, the portion of the width of the sheet which is heated is 1% to 90% of the width. In some embodiments, the portion of the width of the sheet which is heated is 5% to 90% of the width. In some embodiments, the portion of the width of the sheet which is heated is 10% to 90% of the width. In some embodiments, the portion of the width of the sheet which is heated is 20% to 90% of the width. In some embodiments, the portion of the width of the sheet which is heated is 30% to 90% of the width. In some embodiments, the portion of the width of the sheet which is heated is 40% to 90% of the width. In some embodiments, the portion of the width of the sheet which is heated is 50% to 90% of the width. In some embodiments, the portion of the width of the sheet which is heated is 60% to 90% of the width. In some embodiments, the portion of the width of the sheet which is heated is 70% to 90% of the width. In some embodiments, the portion of the width of the sheet which is heated is 80% to 90% of the width.

In some embodiments, the portion of the width of the sheet which is heated is 1% to 80% of the width. In some embodiments, the portion of the width of the sheet which is heated is 5% to 80% of the width. In some embodiments, the portion of the width of the sheet which is heated is 10% to 80% of the width. In some embodiments, the portion of the width of the sheet which is heated is 20% to 80% of the width. In some embodiments, the portion of the width of the sheet which is heated is 30% to 80% of the width. In some embodiments, the portion of the width of the sheet which is heated is 40% to 80% of the width. In some embodiments, the portion of the width of the sheet which is heated is 50% to 80% of the width. In some embodiments, the portion of the width of the sheet which is heated is 60% to 80% of the width. In some embodiments, the portion of the width of the sheet which is heated is 70% to 80% of the width.

In some embodiments, the portion of the width of the sheet which is heated is 1% to 70% of the width. In some embodiments, the portion of the width of the sheet which is heated is 5% to 70% of the width. In some embodiments, the portion of the width of the sheet which is heated is 10% to 70% of the width. In some embodiments, the portion of the width of the sheet which is heated is 20% to 70% of the width. In some embodiments, the portion of the width of the sheet which is heated is 30% to 70% of the width. In some embodiments, the portion of the width of the sheet which is heated is 40% to 70% of the width. In some embodiments, the portion of the width of the sheet which is heated is 50% to 70% of the width. In some embodiments, the portion of the width of the sheet which is heated is 60% to 70% of the width.

In some embodiments, the portion of the width of the sheet which is heated is 1% to 60% of the width. In some embodiments, the portion of the width of the sheet which is heated is 5% to 60% of the width. In some embodiments, the portion of the width of the sheet which is heated is 10% to 60% of the width. In some embodiments, the portion of the width of the sheet which is heated is 20% to 60% of the width. In some embodiments, the portion of the width of the sheet which is heated is 30% to 60% of the width. In some embodiments, the portion of the width of the sheet which is heated is 40% to 60% of the width. In some embodiments, the portion of the width of the sheet which is heated is 50% to 60% of the width.

In some embodiments, the portion of the width of the sheet which is heated is 1% to 50% of the width. In some embodiments, the portion of the width of the sheet which is heated is 5% to 50% of the width. In some embodiments, the portion of the width of the sheet which is heated is 10% to 50% of the width. In some embodiments, the portion of the width of the sheet which is heated is 20% to 50% of the width. In some embodiments, the portion of the width of the sheet which is heated is 30% to 50% of the width. In some embodiments, the portion of the width of the sheet which is heated is 40% to 50% of the width.

In some embodiments, the portion of the width of the sheet which is heated is 1% to 40% of the width. In some embodiments, the portion of the width of the sheet which is heated is 5% to 40% of the width. In some embodiments, the portion of the width of the sheet which is heated is 10% to 40% of the width. In some embodiments, the portion of the width of the sheet which is heated is 20% to 40% of the width. In some embodiments, the portion of the width of the sheet which is heated is 30% to 40% of the width.

In some embodiments, the portion of the width of the sheet which is heated is 1% to 30% of the width. In some embodiments, the portion of the width of the sheet which is heated is 5% to 30% of the width. In some embodiments, the portion of the width of the sheet which is heated is 10% to 30% of the width. In some embodiments, the portion of the width of the sheet which is heated is 20% to 30% of the width.

In some embodiments, the portion of the width of the sheet which is heated is 1% to 20% of the width. In some embodiments, the portion of the width of the sheet which is heated is 5% to 20% of the width. In some embodiments, the portion of the width of the sheet which is heated is 10% to 20% of the width.

In some embodiments, the portion of the width of the sheet which is heated is 1% to 10% of the width. In some embodiments, the portion of the width of the sheet which is heated is 5% to 10% of the width. In some embodiments, the portion of the width of the sheet which is heated is 1% to 5% of the width.

In some embodiments, either or both of the first roll of the first sheet and/or the second roll of the second sheet may be rolled around a center roll that is separate from the first and/or second sheets. In some embodiments, either or both of the first roll of the first sheet and/or the second roll of the second sheet may be rolled around a carboard center roll. In some embodiments, either or both of the first roll of the first sheet and/or the second roll of the second sheet may be rolled around a center roll formed of another material. In some embodiments, either or both of the first roll of the first sheet and/or the second roll of the second sheet may not be rolled around a separate center roll.

In some embodiments, a material of either or both of the first sheet and/or the second sheet may be thermoplastic polyolefin (TPO). In some embodiments, the material of either or both of the first sheet and/or the second sheet may be polyvinyl chloride (PVC). In some embodiments, the material of either or both of the first sheet and/or the second sheet may be Styrene-Butadiene-Styrene (SBS) modified bitumen. In some embodiments, the material of either or both of the first sheet and/or the second sheet may be polymethylmethacrylate (PMMA). In some embodiments, the material of either or both of the first sheet and/or the second sheet may be any combination of the above materials.

In some embodiments, either or both of the first sheet and/or the second sheet may be 50 feet in the longest dimension (that is, 50 feet in length), wherein the length is the dimension measured perpendicular to an axis of the roll. In some embodiments, either or both of the first sheet and/or the second sheet may be 100 feet in length. In some embodiments, either or both of the first sheet and/or the second sheet may be 50 feet to 100 feet in length.

In some embodiments, either or both of the first sheet and/or the second sheet may be 60 inches (5 feet) in the next longest direction (that is, 60 inches in width), wherein the width is the dimension measured parallel to the axis of the roll. In some embodiments, either or both of the first sheet and/or the second sheet may be at least 60 inches (that is, 5 feet) in width. In some embodiments, either or both of the first sheet and/or the second sheet may be 120 inches (that is, 10 feet) in width. In some embodiments, either or both of the first sheet and/or the second sheet may be 144 inches (that is, 12 feet) in width. In some embodiments, either or both of the first sheet and/or the second sheet may be 5 to 12 feet in width. In some embodiments, either or both of the first sheet and/or the second sheet may be 5 to 10 feet in width. In some embodiments, either or both of the first sheet and/or the second sheet may be 10 to 12 feet in width.

In some embodiments, either or both of the first sheet and/or the second sheet may have a thickness of 100 mil. In some embodiments, either or both of the first sheet and/or the second sheet may have a thickness of 90 mil. In some embodiments, either or both of the first sheet and/or the second sheet may have a thickness of 85 mil. In some embodiments, either or both of the first sheet and/or the second sheet may have a thickness of 80 mil. In some embodiments, either or both of the first sheet and/or the second sheet may have a thickness of 75 mil. In some embodiments, either or both of the first sheet and/or the second sheet may have a thickness of 70 mil. In some embodiments, either or both of the first sheet and/or the second sheet may have a thickness of 65 mil. In some embodiments, either or both of the first sheet and/or the second sheet may have a thickness of 60 mil. In some embodiments, either or both of the first sheet and/or the second sheet may have a thickness of 55 mil. In some embodiments, either or both of the first sheet and/or the second sheet may have a thickness of 50 mil. In some embodiments, either or both of the first sheet and/or the second sheet may have a thickness of 45 mil. In some embodiments, either or both of the first sheet and/or the second sheet may have a thickness of 45 mil.

In some embodiments, either or both of the first sheet and/or the second sheet may have a thickness more than 100 mil. In some embodiments, either or both of the first sheet and/or the second sheet may have a thickness more than 90 mil. In some embodiments, either or both of the first sheet and/or the second sheet may have a thickness more than 85 mil. In some embodiments, either or both of the first sheet and/or the second sheet may have a thickness more than 80 mil. In some embodiments, either or both of the first sheet and/or the second sheet may have a thickness more than 75 mil. In some embodiments, either or both of the first sheet and/or the second sheet may have a thickness more than 70 mil. In some embodiments, either or both of the first sheet and/or the second sheet may have a thickness more than 65 mil. In some embodiments, either or both of the first sheet and/or the second sheet may have a thickness more than 60 mil. In some embodiments, either or both of the first sheet and/or the second sheet may have a thickness more than 55 mil. In some embodiments, either or both of the first sheet and/or the second sheet may have a thickness more than 50 mil. In some embodiments, either or both of the first sheet and/or the second sheet may have a thickness more than 45 mil. In some embodiments, either or both of the first sheet and/or the second sheet may have a thickness more than 45 mil.

In some embodiments, either or both of the first sheet and/or the second sheet may have a thickness less than 100 mil. In some embodiments, either or both of the first sheet and/or the second sheet may have a thickness less than 90 mil. In some embodiments, either or both of the first sheet and/or the second sheet may have a thickness less than 85 mil. In some embodiments, either or both of the first sheet and/or the second sheet may have a thickness less than 80 mil. In some embodiments, either or both of the first sheet and/or the second sheet may have a thickness less than 75 mil. In some embodiments, either or both of the first sheet and/or the second sheet may have a thickness less than 70 mil. In some embodiments, either or both of the first sheet and/or the second sheet may have a thickness less than 65 mil. In some embodiments, either or both of the first sheet and/or the second sheet may have a thickness less than 60 mil. In some embodiments, either or both of the first sheet and/or the second sheet may have a thickness less than 55 mil. In some embodiments, either or both of the first sheet and/or the second sheet may have a thickness less than 50 mil. In some embodiments, either or both of the first sheet and/or the second sheet may have a thickness less than 45 mil. In some embodiments, either or both of the first sheet and/or the second sheet may have a thickness less than 45 mil.

In some embodiments, either or both of the first sheet and/or the second sheet may have a thickness of 40 mil to 100 mil. In some embodiments, either or both of the first sheet and/or the second sheet may have a thickness of 45 mil to 100 mil. In some embodiments, either or both of the first sheet and/or the second sheet may have a thickness of 50 mil to 100 mil. In some embodiments, either or both of the first sheet and/or the second sheet may have a thickness of 55 mil to 100 mil. In some embodiments, either or both of the first sheet and/or the second sheet may have a thickness of 60 mil to 100 mil. In some embodiments, either or both of the first sheet and/or the second sheet may have a thickness of 65 mil to 100 mil. In some embodiments, either or both of the first sheet and/or the second sheet may have a thickness of 70 mil to 100 mil. In some embodiments, either or both of the first sheet and/or the second sheet may have a thickness of 75 mil to 100 mil. In some embodiments, either or both of the first sheet and/or the second sheet may have a thickness of 80 mil to 100 mil. In some embodiments, either or both of the first sheet and/or the second sheet may have a thickness of 85 mil to 100 mil. In some embodiments, either or both of the first sheet and/or the second sheet may have a thickness of 90 mil to 100 mil.

In some embodiments, either or both of the first sheet and/or the second sheet may have a thickness of 40 mil to 90 mil. In some embodiments, either or both of the first sheet and/or the second sheet may have a thickness of 45 mil to 90 mil. In some embodiments, either or both of the first sheet and/or the second sheet may have a thickness of 50 mil to 90 mil. In some embodiments, either or both of the first sheet and/or the second sheet may have a thickness of 55 mil to 90 mil. In some embodiments, either or both of the first sheet and/or the second sheet may have a thickness of 60 mil to 90 mil. In some embodiments, either or both of the first sheet and/or the second sheet may have a thickness of 65 mil to 90 mil. In some embodiments, either or both of the first sheet and/or the second sheet may have a thickness of 70 mil to 90 mil. In some embodiments, either or both of the first sheet and/or the second sheet may have a thickness of 75 mil to 90 mil. In some embodiments, either or both of the first sheet and/or the second sheet may have a thickness of 80 mil to 90 mil. In some embodiments, either or both of the first sheet and/or the second sheet may have a thickness of 85 mil to 90 mil.

In some embodiments, either or both of the first sheet and/or the second sheet may have a thickness of 40 mil to 85 mil. In some embodiments, either or both of the first sheet and/or the second sheet may have a thickness of 45 mil to 85 mil. In some embodiments, either or both of the first sheet and/or the second sheet may have a thickness of 50 mil to 85 mil. In some embodiments, either or both of the first sheet and/or the second sheet may have a thickness of 55 mil to 85 mil. In some embodiments, either or both of the first sheet and/or the second sheet may have a thickness of 60 mil to 85 mil. In some embodiments, either or both of the first sheet and/or the second sheet may have a thickness of 65 mil to 85 mil. In some embodiments, either or both of the first sheet and/or the second sheet may have a thickness of 70 mil to 85 mil. In some embodiments, either or both of the first sheet and/or the second sheet may have a thickness of 75 mil to 85 mil. In some embodiments, either or both of the first sheet and/or the second sheet may have a thickness of 80 mil to 85 mil.

In some embodiments, either or both of the first sheet and/or the second sheet may have a thickness of 40 mil to 80 mil. In some embodiments, either or both of the first sheet and/or the second sheet may have a thickness of 45 mil to 80 mil. In some embodiments, either or both of the first sheet and/or the second sheet may have a thickness of 50 mil to 80 mil. In some embodiments, either or both of the first sheet and/or the second sheet may have a thickness of 55 mil to 80 mil. In some embodiments, either or both of the first sheet and/or the second sheet may have a thickness of 60 mil to 80 mil. In some embodiments, either or both of the first sheet and/or the second sheet may have a thickness of 65 mil to 80 mil. In some embodiments, either or both of the first sheet and/or the second sheet may have a thickness of 70 mil to 80 mil. In some embodiments, either or both of the first sheet and/or the second sheet may have a thickness of 75 mil to 80 mil.

In some embodiments, either or both of the first sheet and/or the second sheet may have a thickness of 40 mil to 75 mil. In some embodiments, either or both of the first sheet and/or the second sheet may have a thickness of 45 mil to 75 mil. In some embodiments, either or both of the first sheet and/or the second sheet may have a thickness of 50 mil to 75 mil. In some embodiments, either or both of the first sheet and/or the second sheet may have a thickness of 55 mil to 75 mil. In some embodiments, either or both of the first sheet and/or the second sheet may have a thickness of 60 mil to 75 mil. In some embodiments, either or both of the first sheet and/or the second sheet may have a thickness of 65 mil to 75 mil. In some embodiments, either or both of the first sheet and/or the second sheet may have a thickness of 70 mil to 75 mil.

In some embodiments, either or both of the first sheet and/or the second sheet may have a thickness of 40 mil to 70 mil. In some embodiments, either or both of the first sheet and/or the second sheet may have a thickness of 45 mil to 70 mil. In some embodiments, either or both of the first sheet and/or the second sheet may have a thickness of 50 mil to 70 mil. In some embodiments, either or both of the first sheet and/or the second sheet may have a thickness of 55 mil to 70 mil. In some embodiments, either or both of the first sheet and/or the second sheet may have a thickness of 60 mil to 70 mil. In some embodiments, either or both of the first sheet and/or the second sheet may have a thickness of 65 mil to 70 mil.

In some embodiments, either or both of the first sheet and/or the second sheet may have a thickness of 40 mil to 65 mil. In some embodiments, either or both of the first sheet and/or the second sheet may have a thickness of 45 mil to 65 mil. In some embodiments, either or both of the first sheet and/or the second sheet may have a thickness of 50 mil to 65 mil. In some embodiments, either or both of the first sheet and/or the second sheet may have a thickness of 55 mil to 65 mil. In some embodiments, either or both of the first sheet and/or the second sheet may have a thickness of 60 mil to 65 mil.

In some embodiments, either or both of the first sheet and/or the second sheet may have a thickness of 40 mil to 60 mil. In some embodiments, either or both of the first sheet and/or the second sheet may have a thickness of 45 mil to 60 mil. In some embodiments, either or both of the first sheet and/or the second sheet may have a thickness of 50 mil to 60 mil. In some embodiments, either or both of the first sheet and/or the second sheet may have a thickness of 55 mil to 60 mil.

In some embodiments, either or both of the first sheet and/or the second sheet may have a thickness of 40 mil to 55 mil. In some embodiments, either or both of the first sheet and/or the second sheet may have a thickness of 45 mil to 55 mil. In some embodiments, either or both of the first sheet and/or the second sheet may have a thickness of 50 mil to 55 mil.

In some embodiments, either or both of the first sheet and/or the second sheet may have a thickness of 40 mil to 50 mil. In some embodiments, either or both of the first sheet and/or the second sheet may have a thickness of 45 mil to 50 mil. In some embodiments, either or both of the first sheet and/or the second sheet may have a thickness of 45 mil to 50 mil.

In some embodiments, the compressing zone may be located downstream of the heating zone—that is, the first set of compressing rollers may be downstream of the hot air knife.

In some embodiments, the hot air knife may comprise a heater for heating air. In some embodiments, the hot air knife may comprise a blower. In some embodiments, the hot air knife may comprise an air outlet configured to direct the hot air to either or both of the first and/or second sheets.

In some embodiments, the hot air knife may heat the air to a temperature of at least 600° C. In some embodiments, the hot air knife may heat the air to a temperature of 600° C. In some embodiments, the hot air knife may heat the air to a temperature of more than 600° C. In some embodiments, the hot air knife may heat the air to a temperature of less than 600° C.

In some embodiments, the hot air knife may heat at least a portion of the width of at least one of the first and/or second sheet. In some embodiments, the hot air knife may heat at least a portion of the width of at least one of the first sheet and/or the second sheet with air at a temperature of at least 600° C. In some embodiments, the hot air knife may heat at least a portion of the width of at least one of the first sheet and/or the second sheet with air at a temperature of 600° C. In some embodiments, the hot air knife may heat at least a portion of the width of at least one of the first sheet and/or the second sheet with air at a temperature of more than 600° C. In some embodiments, the hot air knife may heat at least a portion of the width of at least one of the first sheet and/or the second sheet with air at a temperature of less than 600° C.

In some embodiments, the two compressing rollers may be adjacent to the hot air knife. In some embodiments, “adjacent” means that there is no other component between the compressing rollers and the hot air knife.

In some embodiments, rotation of the two compressing rollers may pull the first and/or second sheet through the heating zone and/or the compressing zone.

In some embodiments, the laminated roofing membrane may be cut into one or more laminated roofing strips. In some embodiments, the one or more laminated roofing strips may be 18 inches in length. In some embodiments, the one or more laminated roofing strips may be the width of the first and/or second sheets. In some embodiments, the one or more laminated roofing strips may be used to cover a roof deck of a building structure. In some embodiments, the one or more laminated roofing strips may be used to cover a steep slope roof deck. As used herein, a “steep slope” roof deck is a roof deck that is disposed on a roof having a pitch of Y/X, where Y and X are in a ratio of 4:12 to 20:12, where Y corresponds to the “rise” of the roof, and where X corresponds to the “run” of the roof. In some embodiments, the one or more laminated roofing strips may act as roofing shingles used to cover a steep slope roof deck.

In some embodiments, mechanical fasteners may be used to attach the one or more laminated roofing strips to the roof deck, such as by penetrating the laminated roofing strips and the roof deck above which the roofing strips are installed. In some embodiments, nails may be used to attach the one or more laminated roofing strips to the roof deck. In some embodiments, screws may be used to attach the one or more laminated roofing strips to the roof deck. In some embodiments, staples may be used to attach the one or more laminated roofing strips to the roof deck. In some embodiments, rivets may be used to attach the one or more laminated roofing strips to the roof deck. In some embodiments, an adhesive may be used to attach the one or more laminated roofing strips to the roof deck. In some embodiments, an underlayment may be disposed between the one or more laminated roofing strips and the roof deck.

In some embodiments, the laminated roofing membrane may be textured. In some embodiments, the laminated roofing membrane may be textured using at least one roller. In some embodiments, the laminated roofing membrane may be textured using a set of texturing rollers. In some embodiments, at least one roller of the set of texturing rollers may be a textured roller, and at least one roller of the set of texturing rollers may have an untextured surface. In some embodiments, both of the rollers of the set of texturing rollers may be textured. In some embodiments, the set of texturing rollers may be located downstream of the heating zone. In some embodiments, the set of texturing rollers may be located downstream of the compressing zone. In some embodiments, the set of texturing rollers may be located downstream of the heating zone and the compressing zone. In some embodiments, one or both of the texturing rollers may be heated rollers that reheat the laminated roofing membrane. In some embodiments, neither of the texturing rollers may be heated rollers. In some embodiments, a separate heater may reheat the laminated roofing membrane prior to and/or during the texturing. In some embodiments, another heat knife may reheat the laminated roofing membrane and/or one or more of the texturing rollers, prior to and/or during the texturing.

In some embodiments, the laminated roofing membrane may include a third sheet. In some embodiments, the third sheet may be the same as either or both of the first and/or second sheets. In some embodiments, the third sheet may be the different than either or both of the first and/or second sheets. In some embodiments, the third sheet may be heated by the hot air knife. In some embodiments, at least a portion of a width of the third sheet may be heated by the hot air knife. In some embodiments, an entire width of the third sheet may be heated by the hot air knife. In some embodiments, no portion of the width of the third sheet may be heated by the hot air knife. In some embodiments, the third sheet may be compressed with the first and second sheet, thereby to form the laminated roofing membrane.

In some embodiments, a third sheet may be laminated to the laminated roofing membrane formed by the first and second sheets, thereby to form a three-layer laminated roofing membrane. In some embodiments, the laminated roofing membrane and the third sheet may be compressed between another set of compressing rollers, thereby to form the three-layer laminated roofing membrane. In some embodiments, the third sheet may directly contact the laminated roofing membrane without a scrim layer disposed between the laminated roofing membrane and the third sheet, thereby to form the three-layer laminated roofing membrane.

In some embodiments, widths of any or all of the first, second, and/or third sheets are the same as another sheet or all of the sheets. In some embodiments, widths of any or all of the first, second, and/or third sheets are different that another sheet or all of the sheets.

In some embodiments, the three-layer laminated roofing membrane may be textured with a set of texturing rollers. In some embodiments, the set of texturing rollers may be the as described herein. In some embodiments, the set of texturing rollers may be disposed downstream of the heating zone, the compressing zone, and the second set of compressing rollers. In some embodiments, the textured three-layer laminated roofing membrane may be cut into roofing strips. In some embodiments, the roofing strips may be used as discussed herein.

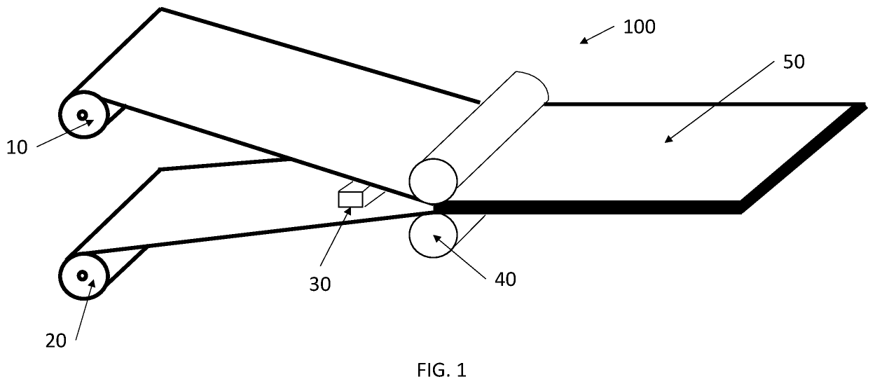

With reference to the figures, FIG. 1 is an isometric view of a system 100, in accordance with some embodiments of the invention. As shown in the figure, in some embodiments, the system 100 may use a first roll of a first sheet 10. The first sheet 10 may be in accordance with any sheet described here. In some embodiments, the first sheet 10 may be in accordance with the first sheet described herein. In some embodiments, the system 100 may also use a second roll of a second sheet 20. The second sheet 20 may be in accordance with any sheet described here. In some embodiments, the second sheet 20 may be in accordance with the second sheet described herein. Although the figures show each of the first sheet 10 and the second sheet 20 on a separate roll, in some embodiments either or both of the sheets may not be on a roll or rolls.

As shown in FIG. 1, in some embodiments, the system 100 may include a hot air knife 30. In some embodiments, the hot air knife 30 may be in accordance with the hot air knife further described herein. In some embodiments, the hot air knife 30 may heat at least a portion of a width of the first sheet 10 with hot air, thereby to form a heated first sheet. In some embodiments, the hot air knife 30 directs hot air toward at least one surface of the first sheet 10. In some embodiments, the hot air knife 30 may heat only a portion of the width of the first sheet 10 with hot air, as described above. In some embodiments, the hot air knife 30 may heat an entirety of the width of the first sheet 10 with hot air, as described above. In some embodiments, the hot air knife 30 directs hot air toward at least one surface of the second sheet 20. In some embodiments, the hot air knife 30 may heat only a portion of the width of the second sheet 20 with hot air, as described. In some embodiments, the hot air knife 30 may heat an entirety of the width of the second sheet 20 with hot air, as described. In some embodiments, the hot air knife 30 may heat only a portion of the width of the first sheet 10 with hot air and only a portion of the width of the second sheet 20 with hot air. In some embodiments, the hot air knife 30 may heat only a portion of the width of the first sheet 10 with hot air and an entirety of the width of the second sheet 20 with hot air. In some embodiments, the hot air knife 30 may heat the entirety of the width of the first sheet 10 with hot air and only a portion of the width of the second sheet 20 with hot air.

In some embodiments, the location at which the hot air knife 30 heats either or both of the first sheet 10 and/or the second sheet 20 may be referred to as a heating zone. In some embodiments, the location at which the hot air knife 30 is located may be referred to as a heating zone. In some embodiments, the location at which the hot air knife 30 heats either or both of the first sheet 10 and/or the second sheet 20 and at which the hot air knife 30 is located may be referred to as a heating zone.

In some embodiments, either or both of the first sheet 10 and/or the second sheet 20 may undergo no other heating prior to heating by the hot air knife 30. In some embodiments, either or both of the first sheet 10 and/or the second sheet 20 may undergo no other heating subsequent to heating by the hot air knife 30. In some embodiments, either or both of the first sheet 10 and/or the second sheet 20 may undergo no other heating prior and subsequent to heating by the hot air knife 30—that is, the only heating either or both of the first sheet 10 and/or the second sheet 20 may undergo may be heating by the hot air knife 30.

As shown in FIG. 1, the system 100 may include a set of compressing rollers 40. In some embodiments, the set of compressing rollers may include two compressing rollers 40. In some embodiments, the compressing rollers 40 may compress the heated first sheet 10 with the second sheet 20, thereby to form a laminated roofing membrane 50. In some embodiments, the compressing rollers 40 may compress the heated first sheet 10 with the heated second sheet 20, thereby to form the laminated roofing membrane 50. In some embodiments, the compressing rollers 40 may compress the first sheet 10 with the heated second sheet 20, thereby to form the laminated roofing membrane 50. In some embodiments, the location where the set of compressing rollers 40 are located may be referred to as the compressing zone.

As shown in the figure, the set of compressing rollers 40 and the hot air knife 30 may be disposed adjacent one another, as described herein.

As shown in the figure, the first sheet 10 and the second sheet 20 may directly contact one another—that is, there may be no intervening layer disposed between the first sheet 10 and the second sheet 20, such as, for example, a scrim layer.

As discussed herein, in some embodiments, the laminated roofing membrane 50 may be cut into lengths, thereby to form one or more laminated roofing strips. In some embodiments, the one or more laminated roofing strips may be as described herein. In some embodiments, the one or more laminated roofing strips may be used to cover a roof deck, such as a steep slope roof deck, as described herein.

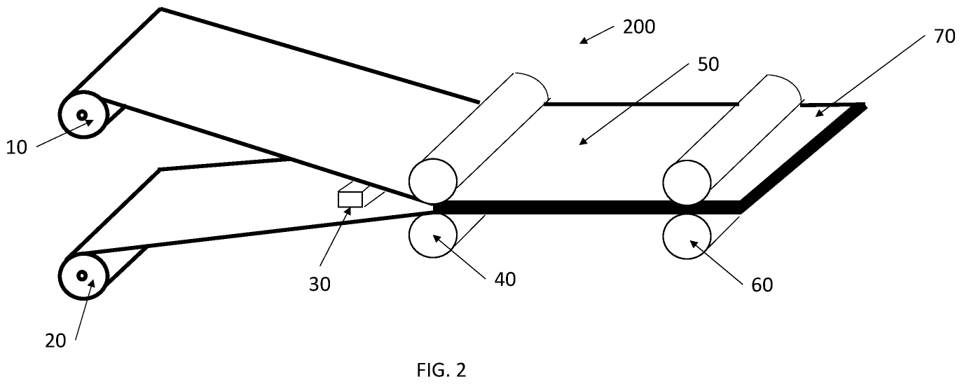

FIG. 2 is an isometric view of a system 200 in accordance with some embodiments of the invention. In some embodiments, the system 200 may differ from system 100 in that system 200 may include a set of texturing rollers 60. In some embodiments, the set of texturing rollers may be two texturing rollers 60. In some embodiments, the texturing rollers 60 may texture one or both sides of the laminated roofing membrane 50, thereby to form a textured laminated roofing membrane 70. In some embodiments, only one of the texturing rollers 60 may have a textured surface to thereby texture one side of the laminated roofing membrane 50, while the other roller 60 has a nontextured surface. In some embodiments, both texturing rollers 60 may have a textured surface for texturing the laminated roofing membrane 50. In some embodiments, the location where the set of texturing rollers 60 are located may be referred to as the texturing zone.

As discussed herein, in some embodiments, the textured laminated roofing membrane 70 may be cut into lengths, thereby to form one or more textured laminated roofing strips. In some embodiments, the one or more textured laminated roofing strips may be as described herein. In some embodiments, the one or more textured laminated roofing strips may be used to cover a roof deck, such as a steep slope roof deck, as described herein.

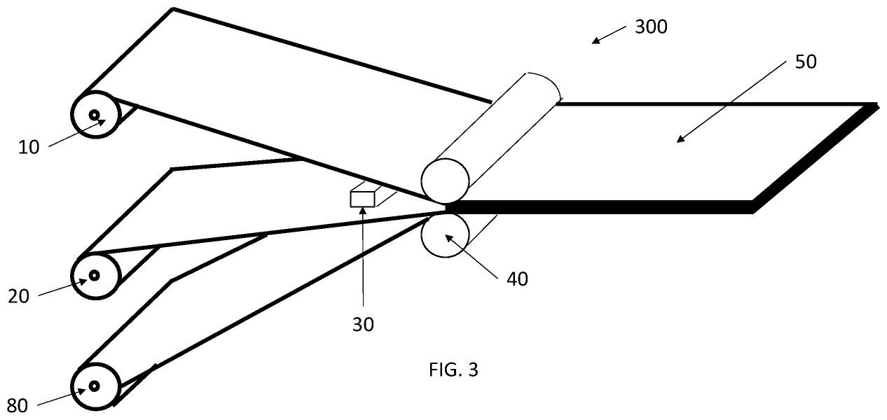

FIG. 3 is an isometric view of a system 300 in accordance with some embodiments of the invention. In some embodiments, the system 300 may differ from systems 100 and 200 in that system 300 may include a third roll of a third sheet 80, to thereby form the laminated roofing membrane 50. In some embodiments, the hot air knife 30 may heat at least a portion of a width of the first sheet 10 with hot air, thereby to form a heated first sheet 10. In some embodiments, the hot air knife 30 may direct hot air toward at least one surface of the first sheet 10. In some embodiments, the hot air knife 30 may heat only a portion of the width of the first sheet 10 with hot air. In some embodiments, the hot air knife 30 may heat an entirety of the width of the first sheet 10 with hot air. In some embodiments, the hot air knife 30 may direct hot air toward at least one surface of the second sheet 20, thereby to form the heated second sheet 20. In some embodiments, the hot air knife 30 may heat only a portion of the width of the second sheet 20 with hot air. In some embodiments, the hot air knife 30 may heat an entirety of the width of the second sheet 20 with hot air. In some embodiments, the hot air knife 30 may heat only a portion of the width of the first sheet 10 with hot air and only a portion of the width of the second sheet 20 with hot air. In some embodiments, the hot air knife 30 may heat only a portion of the width of the first sheet 10 with hot air and an entirety of the width of the second sheet 20 with hot air. In some embodiments, the hot air knife 30 may heat the entirety of the width of the first sheet 10 with hot air and only a portion of the width of the second sheet 20 with hot air. In some embodiments, the system 300 may include another heater, such as another hot air knife, that may heat a surface of the third sheet 80.

As shown in FIG. 3, the system 300 may include the set of compressing rollers 40. In some embodiments, the compressing rollers 40 may compress the heated first sheet 10 with the second sheet 20 and the third sheet 80, thereby to form the laminated roofing membrane 50. In some embodiments, the compressing rollers 40 may compress the heated first sheet 10 with the heated second sheet 20 and with the third sheet 80, thereby to form the laminated roofing membrane 50. In some embodiments, the compressing rollers 40 may compress the first sheet 10 and the third sheet 80 with the heated second sheet 20, thereby to form the laminated roofing membrane 50.

In some embodiments, the laminated roofing membrane 50 may be cut into lengths, thereby to form one or more laminated roofing strips, in accordance with the discussion herein. In some embodiments, the one or more laminated roofing strips may be as described herein. In some embodiments, the one or more laminated roofing strips may be used to cover a roof deck, such as a steep slope roof deck, as described herein.

In some embodiments, the laminated roofing membrane 50 may be textured, such as by a set of texturing rollers, as described herein.

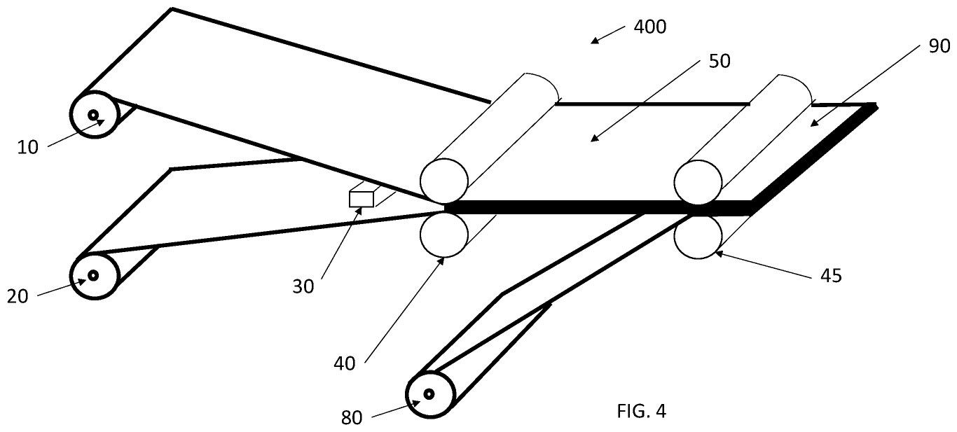

FIG. 4 is an isometric view of a system 400 in accordance with some embodiments of the invention. In some embodiments, the system 400 may differ from systems 100, 200, and 300 in that system 400 may include a second set of compressing rollers 45. In some embodiments, the compressing rollers 45 may compress the laminated roofing membrane 50, which is a two-layer laminated membrane, and the third sheet 80, thereby to form a three-layer laminated roofing membrane 90.

In some embodiments, the three-layer laminated roofing membrane 90 may be cut into lengths, thereby to form one or more three-layer laminated roofing strips, in accordance with the discussion herein. In some embodiments, the one or more three-layer laminated roofing strips may be as described herein. In some embodiments, the one or more three-layer laminated roofing strips may be used to cover a roof deck, such as a steep slope roof deck, as described herein.

In some embodiments, the three-layer laminated roofing membrane 90 may be textured, such as by a set of texturing rollers, as described herein.

In some embodiments, any of the laminated roofing membranes and/or laminated roofing strips of the invention may have matte (e.g., non-shiny) outer surfaces, indicating that no heating of the outer surfaces of any of the first, second, and/or third sheets has occurred.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A method, comprising:
obtaining a first roll of a first sheet,
wherein the first sheet comprises thermoplastic polyolefin (TPO), and
wherein the first sheet has a width of at least 60 inches measured parallel to an axis of the first roll of the first sheet;
obtaining a second roll of a second sheet,
wherein the second sheet comprises thermoplastic polyolefin (TPO), and
wherein the second sheet has a width of at least 60 inches measured parallel to an axis of the second roll of the second sheet;
heating at least a portion of a width of the first sheet with hot air from a hot air knife, thereby to form a heated first sheet; and
compressing the heated first sheet and the second sheet with one another between two rollers, thereby to form a laminated roofing membrane,
wherein the heated first sheet and the second sheet directly contact one another without a scrim layer disposed between the heated first sheet and the second sheet.

2. The method of claim 1, wherein the hot air knife heats an entirety of the width of the first sheet.

3. The method of claim 2, wherein the hot air knife heats the entire width of the first sheet with the hot air at a temperature of at least 600° C.

4. The method of claim 1, wherein the heating further comprises heating at least a portion of the width of the second sheet with the hot air from the hot air knife, thereby to form a heated second sheet, and
wherein the compressing further comprises compressing the heated first sheet and the heated second sheet with one another between the two rollers.

5. The method of claim 1, wherein the widths of the first sheet and the second sheet are the same, and each of the widths is 60 inches to 120 inches.

6. The method of claim 1, wherein at least one of the first sheet and the second sheet has a thickness of 80 mils.

7. The method of claim 1, further comprising:
cutting the laminated roofing membrane, thereby to form a first laminated roofing strip.

8. The method of claim 1, further comprising:
texturing the laminated roofing membrane, thereby to form a textured laminated roofing membrane.

9. The method of claim 8, wherein the texturing comprises using at least one texturing roller to texture the laminated roofing membrane.

10. The method of claim 9, further comprising:
cutting the textured laminated roofing membrane, thereby to form a first textured laminated roofing strip.

11. The method of claim 1, wherein neither the first sheet nor the second sheet is heated prior to the heating the at least a portion of the width of the first sheet with the hot air knife.

12. The method of claim 1, wherein there is no adhesive between the heated first sheet and the second sheet.

13. A method comprising:
obtaining a first roll of a first sheet,
wherein the first sheet comprises thermoplastic polyolefin (TPO), and
wherein the first sheet has a width of at least 60 inches measured parallel to an axis of the first roll of the first sheet;
obtaining a second roll of a second sheet,
wherein the second sheet comprises thermoplastic polyolefin (TPO), and
wherein the second sheet has a width of at least 60 inches measured parallel to an axis of the second roll of the second sheet;
obtaining a third roll of a third sheet,
wherein the third sheet comprises thermoplastic polyolefin (TPO), and
wherein the third sheet has a width of at least 60 inches measured parallel to an axis of the third roll of the third sheet;
heating at least a portion of a width of the first sheet with hot air from a hot air knife, thereby to form a heated first sheet; and
compressing the heated first sheet, the second sheet, and the third sheet with one another, thereby to form a laminated roofing membrane.

14. The method of claim 13, further comprising:
texturing the laminated roofing membrane, thereby to form a textured laminated roofing membrane.

15. The method of claim 14, further comprising:
cutting the textured laminated roofing membrane, thereby to form a first textured laminated roofing strip.

16. The method of claim 13, further comprising:
cutting the laminated roofing membrane, thereby to form a laminated roofing strip.

17. A method comprising:
obtaining a first roll of a first sheet,
wherein the first sheet comprises thermoplastic polyolefin (TPO), and
wherein the first sheet has a width of at least 60 inches measured parallel to an axis of the first roll of the first sheet;
obtaining a second roll of a second sheet,
wherein the second sheet comprises thermoplastic polyolefin (TPO), and
wherein the second sheet has a width of at least 60 inches measured parallel to an axis of the second roll of the second sheet;
obtaining a third roll of a third sheet,
wherein the third sheet comprises thermoplastic polyolefin (TPO), and
wherein the third sheet has a width of at least 60 inches measured parallel to an axis of the third roll of the third sheet;
heating at least a portion of a width of the first sheet with hot air from a hot air knife, thereby to form a heated first sheet; and
compressing the heated first sheet and the second sheet with one another, thereby to form a two-layer laminated membrane; and
compressing the two-layer laminated membrane and the third sheet with one another, thereby to form a three-layer laminated roofing membrane.

18. The method of claim 17, wherein the third sheet is not heated prior to the compressing the two-layer laminated membrane and the third sheet.

19. The method of claim 17, wherein the third sheet is heated prior to the compressing the two-layer laminated membrane and the third sheet.

20. The method of claim 17, further comprising:
cutting the three-layer laminated roofing membrane, thereby to form a roofing strip.
